(19) United States
(12) Patent Application Publication
(10) Pub. No.: US 2005/0138475 A1
(43) Pub. Date: Jun. 23, 2005

(54) Apparatus and method for indicating system status in an embedded system

(76) Inventor: Michael J. Stevens, Colorado Springs, CO (US)

Correspondence Address: PAULA D. MORRIS;THE MORRIS LAW FIRM, P.C., 10260 WESTHEIMER, SUITE 360, HOUSTON, TX, 77042-3110, US

(21) Appl. No.: 10/726,769

(22) Filed: Dec. 3, 2003

(51) Int. Cl. G06F 11/00

(52) U.S. Cl. 714/36

(57) ABSTRACT

An embedded system, such as a headless embedded system, including an indicator capable of being illuminated to indicate an operating status of the system. An application determines if the system is operating correctly, for example by monitoring the presence of pre-determined processes running on the system. If the system is operating correctly, the application causes the indicator to be illuminated. Optionally, a second indicator, or a different state of the first indicator, can be used to indicate that the system is not operating correctly.

### BACKGROUND OF THE INVENTION

Embedded systems, e.g. a computer that is a component in a larger system and relies on its own microprocessor, are becoming commonplace. For example, embedded systems are being used in personal electronic items such as PDAs, inkjet printers, cell phones, and car radios. Embedded systems are also becoming critical components of many industrial devices such as test and measurement systems, including the AGILENT TECHNOLOGIES J6802A and J6805A Distributed Network Analyzers.

To meet this growing demand, operating system providers, such as MICROSOFT, provide embedded versions of their normal operating systems. One of the more recent offerings from MICROSOFT is WINDOWS XP EMBEDDED (referred to herein as XPE). Embedded systems, such as XPE, provide functionality that recognizes the nature of embedded systems. One of the most important functions is to protect critical data, such as the operating system or files from being corrupted.

Embedded systems, much like personal computer systems generally store data in memory and/or mass storage. Mass storage may comprise, for example, a variety of persistent components, including removable and non-removable storage drives such as hard drives and compact flash media. Memory is largely comprised of non-persistent components, such as RAM. The data stored in memory is subject to corruption due to power surges, hard power downs, viruses, and so on. Even though embedded system have functionality, such as write filters, that seek to prevent corruption, they are not always effective and it is a fact of life that data gets corrupted.

Although corrupted data may be cleared from non-persistent components by rebooting, it is much more difficult to remove corrupted data from persistent components—especially when the persistent component is the hard drive which stores a computer system's operating system. Corruption of operating system files can lead to intermittent failures that may compromise the operation of the system. In test and measurement systems, such failures can lead to erroneous test results, incorrect diagnosis and unnecessary repairs and troubleshooting.

In many non-embedded systems, a video display, e.g. a monitor, is provided to facilitate monitoring the operation of the system. By watching the monitor it is possible to detect or predict some error that occur due to corruption. In particular, errors associated with the starting of the system may be detected. Further, the operating system can be configured to create a display on the monitor warning of error conditions caused by corruption or other factors. Conversely, many embedded systems are utilized with out any form of display, monitor or otherwise. Such embedded systems are often referred to as “headless” systems. Interaction with headless systems is usually remote from the system via a communication channel, such as the internet.

An example of a headless system is distributed test devices co-located with network components or other convenient access point. Distributed test devices monitor the component or access point and reports the results of the monitoring using the network being monitored or some other communication channel. The ideal situation is that human involvement at the component or access point is limited to installation and activation of the headless test system. However, without a local monitor, it is difficult to determine on-site whether the headless embedded system is operating in a normal manner. Such determinations are made remotely via a selected communication channel.

In person, most headless systems simply look like metal boxes with a power light that indicates the system is ON. The power light does not indicate the status of the operating system or any services provided by application software on the embedded system. Some headless systems are further provided with indicator lights indicating traffic and activity on monitored communication channels. No known headless systems provide a visual indicator of the status of the operating system or services provided by applications associated with the system.

It is know to generate a sound when the operating system of embedded systems has completed a start-up process. For example XPE can be configured to generate such a sound upon completion of startup. Audio indicators are lacking in two manners. First, the sound only indicates that the operating system has started correctly. The sound does not indicate that that any services provided by applications associated with the embedded system are fully functioning. Second, and perhaps most importantly, many embedded systems are installed in switching centers that comprise small rooms with racks of networking equipment, many of which comprise embedded system. Most of these systems are fan cooled such that the ambient noise level in the room is quite high and can mask any sound generated on PC speakers.

Currently, the only way to determine the status of most such headless systems is to remotely access the system via the communication channel associated with the system. Accordingly, the present inventors have recognized a need for apparatus and methods for determining, on location, that an embedded system, and in particular a headless embedded system, is functioning.

### BRIEF DESCRIPTION OF THE DRAWINGS

An understanding of the present invention can be gained from the following detailed description of the invention, taken in conjunction with the accompanying drawings of which:

FIG. 1 is a block diagram of an embedded system in accordance with an embodiment of the present invention.

FIG. 2 is a schematic diagram of an indicator circuit in accordance with an embodiment of the present invention.

FIG. 3 is a flow chart of a method in accordance with an embodiment of the present invention.

### DETAILED DESCRIPTION

Reference will now be made in detail to the present invention, examples of which are illustrated in the accompanying drawings, wherein like reference numerals refer to like elements throughout. In addition to the described apparatus, the detailed description which follows presents methods that may be embodied by routines and symbolic representations of operations of data bits within a computer readable medium, associated processors, embedded systems, general purpose personal computers and the like. The methods presented herein are sequences of steps or actions implemented by a processor leading to a desired result, and as such, encompasses such terms of art as “software,” “routines,” “computer programs,” “programs,” “objects,” “functions,” “subroutines,” and “procedures.” These descriptions and representations are the means used by those skilled in the art effectively convey the substance of their work to others skilled in the art.

The methods of the present invention will be described with respect to implementation on a headless embedded computer system using an embedded operating system. Those of ordinary skill in the art will recognize that the apparatus and methods recited herein may also be implemented on embedded systems with monitors and even on general purpose computing devices, with or without monitors. More to the point, the apparatus and methods presented herein are not inherently related to any particular device or operating system. Rather, various devices and operating systems may be used in accordance with the teachings herein. Machines that may perform the functions of the present invention include those manufactured by such companies as AGILENT TECHNOLOGIES, INC., and HEWLETT PACKARD as well as other manufacturers of embedded systems and general computing devices.

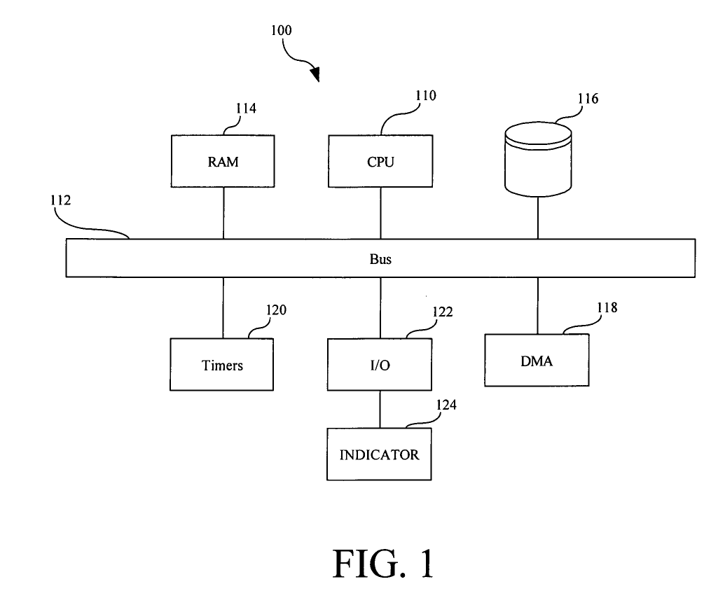

FIG. 1 is a block diagram of an embedded system 100 in accordance with an embodiment of the present invention. The embedded system 100 generally comprises: a CPU 110 connected by a bus 112 to: RAM 114; disk storage 116; DMA (direct memory access) controller 118; timers 120; and an I/O subsystem 122. The disk storage 116 stores the operating system along with applications and data and may be divided into a plurality of partitions. The embedded system 100 shown in FIG. 1 lacks a monitor and, as such, is a headless system.

An indicator 124, connected to the I/O subsystem 122, provides and indication that the embedded system is operational in addition to being ON. Preferably, but not necessarily, this indication takes the form of a two color light emitting diode wherein one color is illuminated when certain conditions, generally reflective of an operational system, are present and a second color with the conditions are not present—generally indicating a non-operational system.

It is to be noted that the block diagram shown in FIG. 1 has been simplified to avoid obscuring the present invention. There are functional components that have been left out or conveniently combined with other functional components selected for inclusion in FIG. 1. Further, the block diagram shown in FIG. 1 is but one of many architectures upon which the present invention may be practiced. The architecture show in FIG. 1 is sometimes termed the “PC architecture” because it resembles an early personal computer. This architecture was chosen for describing the present invention, as it is universally recognizable to those of ordinary skill in embedded system design.

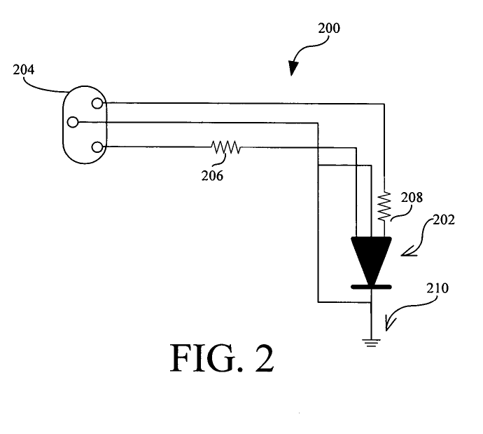

FIG. 2 is a schematic diagram of an indicator circuit in accordance with an embodiment of the present invention. In general, the indicator circuit preferably comprises a two-color LED connected to an input/output (I/O) port 204 associated with the embedded system. For example the I/O port 204 could comprise a serial port or a parallel port connected to a data bus of the embedded system. Referring to FIG. 1, the I/O port 204 may be part of the I/O subsystem 122. Two signal lines and a ground line drive the two color LED 202. The signal lines may be attenuated using resistors 206 and 208.

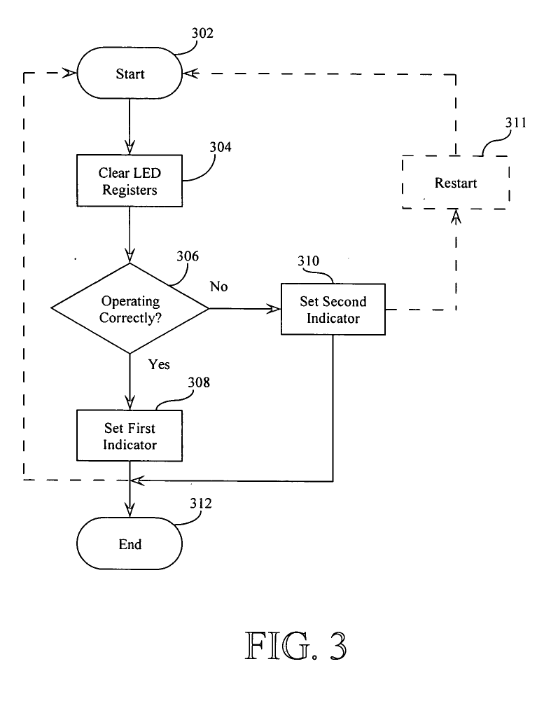

In perhaps the preferred embodiment, the I/O port 204 is a serial RS-232 port wherein the signal lines are controlled by registers accessible by the CPU. In a PC architecture running the XPE system, an added benefit is obtained in that certain registers associated with the serial ports, such as COM1, are set high upon startup. With a two color LED (for example green and red), this activates both light sources giving an amber glow. Thus, as the system starts up, the indicator will glow a third color (for example amber) and, in accordance with the embodiment described herein below with respect to FIG. 3 will turn one of two colors (for example either green or red) depending on the state of the system.

FIG. 3 is a flow chart of a method in accordance with an embodiment of the present invention. The method starts in step 302. In one embodiment, the method is embodied in an application program that is called as part of the boot process of the embedded system. In perhaps the preferred embodiment, the application is called by a service that is automatically run as part of the boot process.

In step 304 registers associated with indicator are cleared. In one configuration, as described hereinabove, this extinguishes the indicator, e.g. the LED 210.

In step 306 a check is made to determine if the embedded system is operating correctly. This may be accomplished, for example, by querying the operating system to determine if certain processes are active. In the context of a Windows Operating system and other similar systems, the term process refers to: an executable program, such as EXPLORER; a service, such as Event Log; or a subsystem, such as the subsystem for WINDOWS 3.x applications. In XPE, services are long-running executable applications that run in their own Windows sessions. These services can be automatically started when the computer boots, can be paused and restarted, and do not show any user interface.

In accordance with an embodiment of the present invention, the availability of processes associated with the functionality of the embedded system are checked, for example, by noting their presence on the process list maintained by the operating system. For example, it may be desirable that TCP/IP services be available along with an FTP server. In XPE, the Microsoft Networking TCP/IP stack and the File Transfer Protocol (FTP) server service provide such services. For headless systems using the XPE system, it may prove useful to ensure that the RDP (remote desktop protocol) is available.

If the system is determined to be operating correctly, the method proceeds to step 308 and an indicator is activated in a first state. For example, referring to FIG. 2, the LED 202 could be lit with a first color, such as green, by setting a register associated with the first signal line. If, in step 306, the system is determined to have started incorrectly, the method proceeds to step 310 and the indicator is activated in a second state. For example, referring to FIG. 2, the LED 202 could be lit with a second color, such as red, by setting a register associated with the second signal line. In either event, the method ends in step 312.

Although an embodiment of the present invention has been shown and described, it will be appreciated by those skilled in the art that changes may be made in these embodiments without departing from the principles and spirit of the invention, the scope of which is defined in the claims and their equivalents.

For example, when the system is determined to have started incorrectly in step 306, it may be automatically restarted, shown in dashed lines as optional step 311 in FIG. 3, in an attempt to clear the condition that caused the problem. The number of restarts attempted can be limited using a file containing a counter that is reset upon the successful startup of the system. As another example, the method shown in FIG. 3 can be continually run to provide, not only an indication as to whether the system started correctly, an indication of the operational status of the system. In yet another example, the method can be modified to produce a log of the queries made and the processes found during each test of the system.

1. A headless embedded system comprising:
an indicator capable of being illuminated;
an operating system;
applications that perform a function for which the headless embedded system was designed;
a processor responsive to an operating system and applications; and
an application that determines if the system is operating correctly, wherein if the system is operating correctly the application causes the indicator to be illuminated.

2. A headless embedded system, as set froth in claim 1, wherein the application determines the operating status of the system by determining whether a predetermined set of processes are active.

3. A headless embedded system, as set forth in claim 1, further comprising:
an input/output port in communication with the processor and the indicator, whereby the application instructs the processor to output a signal via the input/output port to the indicator.

4. A headless embedded system, as set forth in claim 1, wherein the indicator comprises an LED.

5. A headless embedded system, as set forth in claim 1, wherein the application causes the indicator to be illuminated with a first color if the operating system booted correctly and causes the indicator to be illuminated with a second color if the operating system failed to booted correctly.

6. A headless embedded system, as set forth in claim 5, wherein the indicator comprises a two color LED.

7. A headless embedded system, as set froth in claim 5, wherein the application determines whether the operating system booted correctly by determining whether a predetermined set of processes are active.

8. A headless embedded system, as set forth in claim 1, wherein the application causes the indicator to be illuminated with a first color if the system is operating correctly and causes the indicator to be illuminated with a second color if the system fails to operate correctly.

9. A headless embedded system, as set forth in claim 8, wherein the indicator comprises a two color LED.

10. A headless embedded system, as set froth in claim 7, wherein the application determines the operating status of the system by determining whether a predetermined set of processes are active.

11. A method for indicating the operating status of a headless embedded system, the method comprising:
booting the system;
determining if the system is operating correctly; and
illuminating a first indicator if the system is operating correctly.

12. The method, as set forth in claim 11, wherein the step of determining if the system is operating correctly comprises determining whether a predetermined set of processes are active.

13. The method, as set forth in claim 11, further comprising:
executing software that initiates a predetermined set of processes; and
wherein the step of determining if the system is operating correctly comprises determining whether a predetermined set of processes are active.

14. The method, as set forth in claim 11, further comprising:
illuminating a second indicator if the system is not operating correctly.

15. The method, as set forth in claim 11, further comprising:
restarting the system when it is determined that the system is not operating correctly.

16. A headless embedded system comprising:
an indicator capable of being illuminated;
an operating system which maintains a list of processes active on the system;
a processor responsive to an operating system and applications;
a serial port connected to the indicator;
registers used to control the output voltages on the serial port; and
an application that checks the processes active on the system and if a predetermined set of processes are active sets a register causing the indicator to be illuminated in a first color.

17. A headless embedded system, as set forth in claim 16, wherein the indicator is capable of being illuminated in a first and second color and wherein the application checks the processes active on the system and if a predetermined set of processes are not active sets a register causing the indicator to be illuminated in a second color.
